(19) United States
(12) Patent Application Publication
(10) Pub. No.: US 2015/0311596 A1
(43) Pub. Date: Oct. 29, 2015

(54) DIELECTRIC HOLLOW ANTENNA

(71) Applicant: Honeywell International Inc., Morristown, NJ (US)

(72) Inventor: Fouad Nusseibeh, Champlin, MN (US)

(73) Assignee: Honeywell International Inc., Morristown, NJ (US)

(21) Appl. No.: 14/260,566

(22) Filed: Apr. 24, 2014

(51) Int. Cl. H01Q 13/24

(52) U.S. Cl. CPC H01Q 13/24

(57) ABSTRACT

A dielectric hollow antenna apparatus includes a hollow inside tapered rod (e.g., a waveguide) with a flat section and a cap. The antenna further includes a feed through section, a feed pin, and a metal flange. A low loss dielectric material fills the hollow rod that protrudes beyond the metal waveguide to form a radiating element. The radiating element is designed in such a way to maximize radiation and minimize reflections over the antenna bandwidth. The feed through section reduces internal reflection and the waveguide is designed to include a rectangular waveguide that support a propagation (TE01) mode and the waveguide then transitions to a circular waveguide that supports another propagation (TE11) mode. The antennas can be employed for radar level gauging and withstand high temperature and possesses a small diameter that permits the antenna to fit in small tank nozzles.

### FIELD OF THE INVENTION

Embodiments are generally related to dielectric antennas. Embodiments are also related to radar antennas. Embodiments are additionally related to a dielectric hollow antenna.

### BACKGROUND

A dielectric antenna such as a dielectric rod antenna is a surface-wave antenna in which an end-fire radiation pattern is produced by propagation of a surface wave on a tapered dielectric rod. Dielectric rod antennas provide significant performance advantages and are low cost alternatives to free space high-gain antennas at millimeter-wave frequencies and the higher end frequencies of the microwave band. Conventional dielectric antennas required for radar level gauging do not withstand high temperatures. Additionally, such antennas must be installed via small tank nozzles which can affect gain, return loss, and side lobes over the radar bandwidth issues.

Based on the foregoing, it is believed that a need exists for an improved dielectric hollow antenna, which will be described in greater detail herein.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved dielectric antenna.

It is another aspect of the disclosed embodiments to provide for a dielectric hollow antenna capable of withstanding high temperatures, maximizing radiation, and minimizing reflections over the antenna bandwidth.

The aforementioned aspects and other objectives and advantages can now be achieved as described herein. A dielectric hollow antenna is disclosed, which includes a hollow inside tapered rod with a flat section and a cap to form a waveguide. The antenna is further configured to include a feed through section, a feed pin, and a metal flange. A low loss dielectric material (e.g., Teflon) can fill the hollow rod that protrudes beyond the metal waveguide to form a radiating element. The radiating element is designed in such a manner as to maximize radiation and minimize reflections over the antenna bandwidth. The feed through section reduces internal reflection and the waveguide can be designed as a rectangular waveguide that supports a propagation (TE01) mode. The waveguide can then transition to a circular waveguide that supports another propagation (TE11) mode.

The end of the hollow rod can be tapered so as to converge towards the end of the antenna. The feed pin guides the waves from the feed through section into the hollow inside tapered rod. The antenna can be configured utilizing a single dielectric material capable of withstanding high temperatures while possessing a small diameter that permits the antenna to fit in, for example, a small tank nozzle. The antenna can be employed for radar level gauging applications that involve a high gain, a very low return loss, and low side lobes over the radar bandwidth.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a dielectric hollow antenna, in accordance with the a preferred embodiment;

FIG. 2 illustrates an exploded view of the dielectric hollow antenna, in accordance with a preferred embodiment;

FIG. 3 illustrates an electric field radiation with respect to the dielectric hollow antenna, in accordance with a preferred embodiment;

FIG. 4 illustrates a graphical representation of a reflection model and measurement with respect to the dielectric hollow antenna, in accordance with alternative embodiments;

FIGS. 5-6 illustrates a graphical representation of a distance profile with respect to the dielectric hollow antenna, in accordance with alternative embodiments; and

FIG. 7 illustrates a graphical representation of a directivity radiation pattern with respect to the dielectric hollow antenna, in accordance with alternative embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As required, detailed embodiments are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the disclosed embodiments.

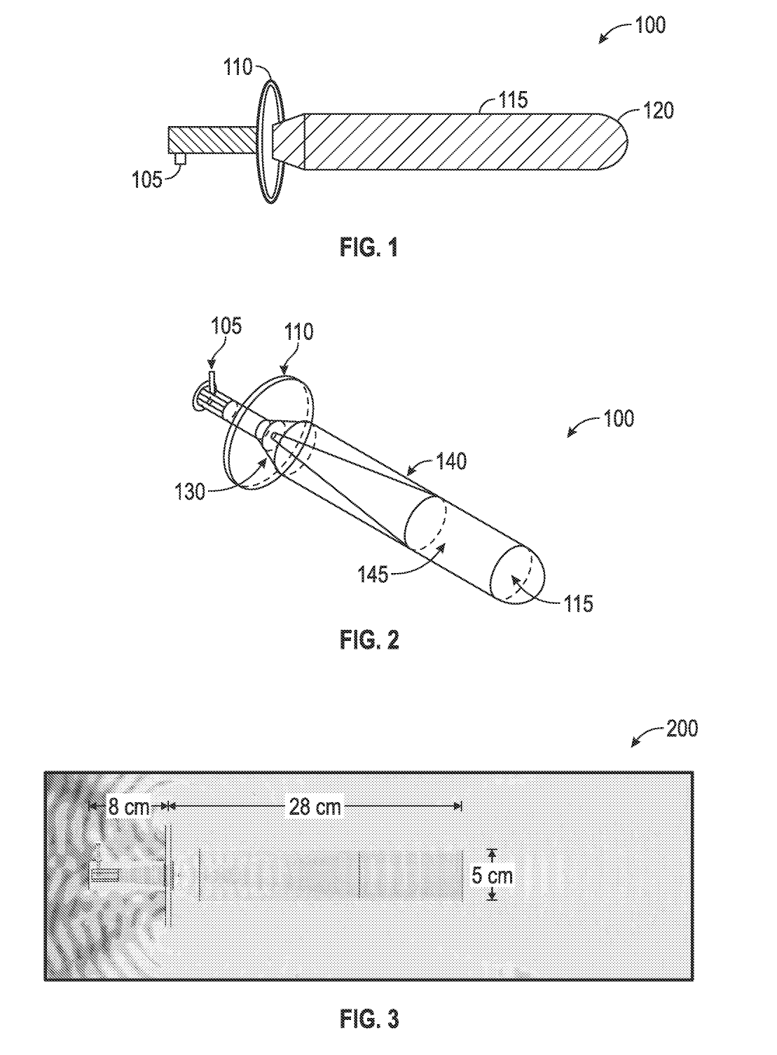

FIG. 1 illustrates a perspective view of a dielectric hollow antenna 100, in accordance with a preferred embodiment. The dielectric hollow antenna 100 includes a hollow inside tapered rod (waveguide) 115 with a flat section and a cap 120. The antenna 100 further includes a feed through section 110, a feed pin 105, and a metal flange 130. A low loss dielectric material can fill the hollow rod 115 that protrudes beyond the metal waveguide 115 to form a radiating element 145. The end of the hollow rod 115 can be tapered so as to converge towards the end of the antenna 100. The converging tapered end of the rod 115 improves matching in regard to wave propagation characteristics when the wave is guided from the feed through section 110 to the dielectric hollow rod 115. The feed pin 105 can guide the waves from the feed through section 110 into the hollow inside tapered rod 115.

FIG. 2 illustrates an exploded view of the dielectric hollow antenna 100, in accordance with a preferred embodiment. The dielectric rod 100 can be gradually tapered to form a tapered section 140 from the maximum diameter portion to the cap portion 120. Note that the hollow rod can be formed of, for example, Teflon material, depending upon design consideration. It can be appreciated of course that the embodiments described herein are not limited to the use of Teflon, but may be configured to include the use of other types of materials. The radiating element 145 can be configured in such a way as to maximize radiation and minimize reflections over the antenna bandwidth.

FIG. 3 illustrates an electric field radiation pattern 200 with respect to the dielectric hollow antenna 100, in accordance with the disclosed embodiments. Note that the feed through section 115 will be the part of the antenna 100. The feed through section 115 reduces internal reflection and the waveguide 115 comprises a rectangular waveguide that supports a propagation (TE01) mode and the waveguide then transitions to a circular waveguide that supports another propagation (TE11) mode.

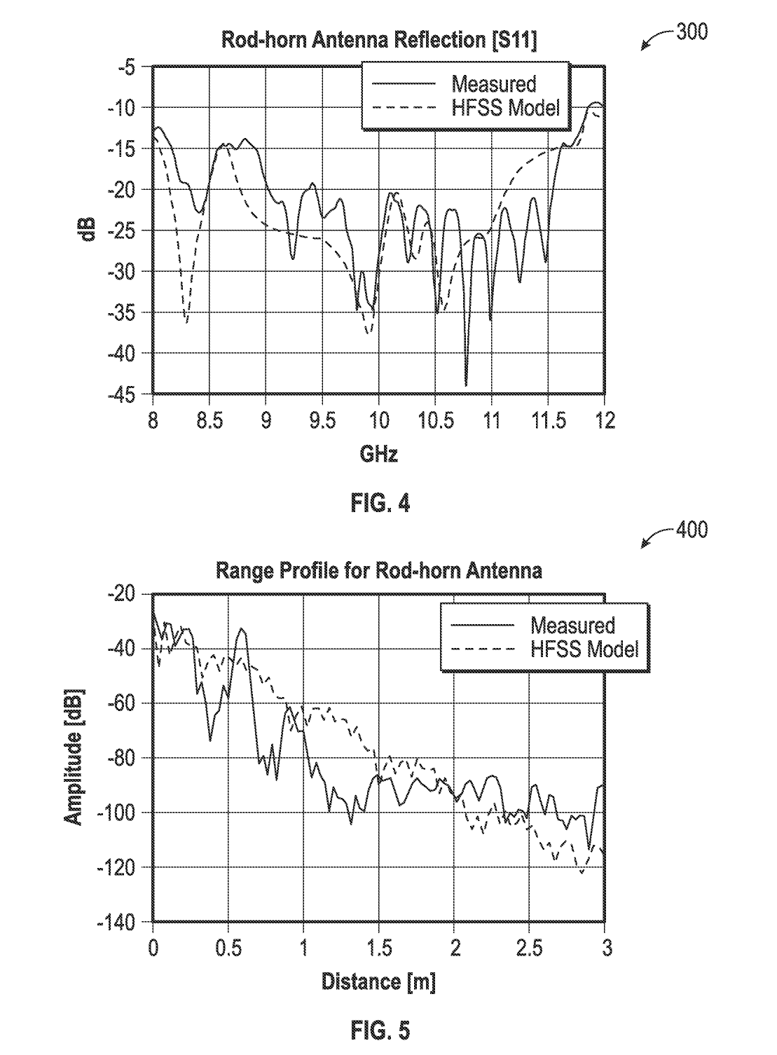

FIG. 4 illustrates a graphical representation 300 of a reflection model and measurement with respect to the dielectric hollow antenna 100, in accordance with an alternative embodiment. In general, a port can be loosely defined as any place where voltage and current is delivered. So, if communication system with two radios (radio 1 and radio 2), then the radio terminals (i.e., which deliver power to the two antennas) can be the two ports. S11 represents the reflected power radio 1 is trying to deliver to antenna 1. S11 of the dielectric hollow antenna 100 is −21 dB over bandwidth (e.g. 9.5-10.5) GHz (e.g. target<=−15 dB).

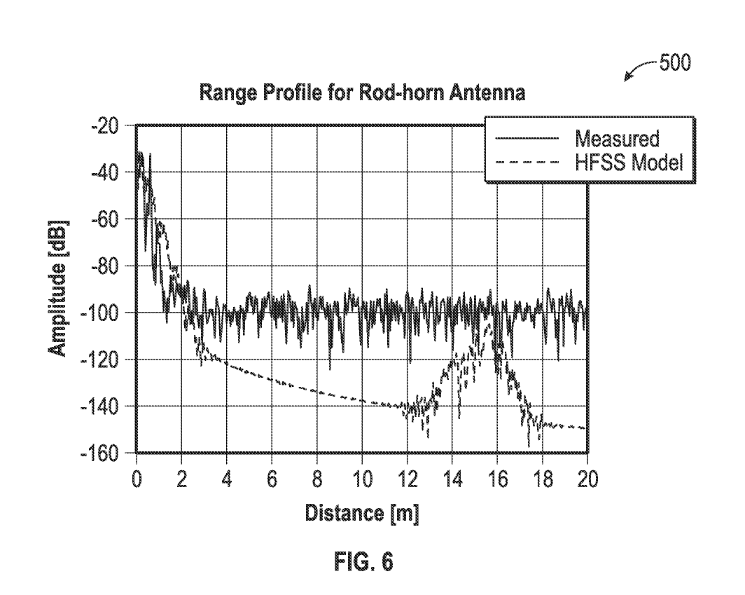

FIGS. 5-6 illustrate a graphical representation of a distance profile 400 and 500 over 3 m and 20 m with respect to the dielectric hollow antenna 100, in accordance with an alternative embodiment. The dielectric hollow antenna 100 can be designed using single dielectric material that can withstand high temperatures and possesses a small diameter that permits the dielectric hollow antenna 100 to fit in small tank nozzles. The simplest way to define the width of a beam is to choose two diametrically opposite points at which the irradiance is a specified fraction of the beam's peak irradiance, and take the distance between them as a measure of the beam's width. An obvious choice for this fraction is ½ (−3 dB), in which case the diameter obtained is the full width of the beam at half its maximum intensity (FWHM). This is also called the half-power beam width (HPBW). The half-power beam width (HPBW) of the dielectric hollow antenna 100 is 180 (target 160), diameter of 5 cm (target<=10 cm).

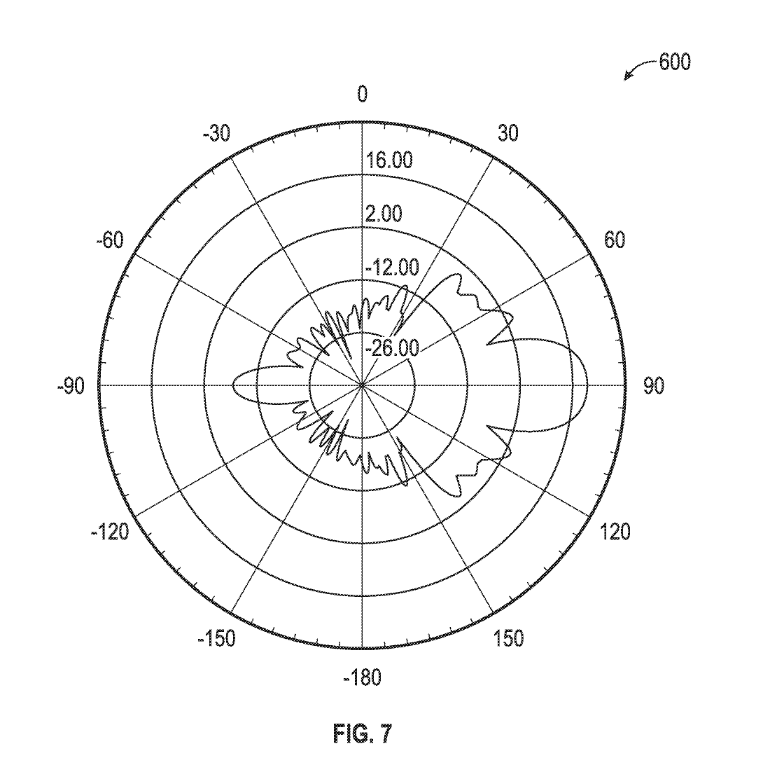

FIG. 7 illustrates a graphical representation of a directivity radiation pattern 600 with respect to the dielectric hollow antenna 100, in accordance with an alternative embodiment. The directivity radiation pattern 600 of the hollow antenna 100 is 20.5 db with a target of 21 db. The dielectric hollow antenna 100 can withstand high temperature and can be installed through the small tank nozzle. The dielectric hollow antenna 100 can be readily adapted to radar level gauging, while offering a comparatively low cost of construction, and can be readily assembled. Antenna 100 also presents a low risk of damage to the electronics during assembly or operation, is accurate and reliable in operation, and is more readily cleaned than known prior art devices. When utilized in the context of the preferred embodiment illustrated and described herein above, the apparatus 100 can offer high gain, very low return loss, and low side lobes over the radar bandwidth.

Based on the foregoing, it can be appreciated that a number of embodiments, preferred and alternative, are disclosed herein. For example, in one embodiment, a dielectric hollow antenna apparatus can be implemented, which includes, for example: a waveguide configured from a hollow inside tapered rod with a flat section and a cap; a low loss dielectric material located within the hollow inside tapered rod, which protrudes beyond the waveguide to form a radiating element; and a feed through section, a feed pin, and a metal flange, wherein the feed through section reduces an internal reflection, and the antenna is installed via a tank nozzle for radar level gauging and to withstand high temperatures.

In another embodiment, the aforementioned waveguide can include or be configured as a waveguide that supports a TE01 propagation mode and then transitions to a circular waveguide that supports a TE11 propagation mode. In yet another embodiment, the radiating element can be configured to maximize radiation and minimize reflection over an antenna bandwidth. In still another embodiment, the dielectric material can be a material capable of withstanding high-temperatures. In yet another embodiment, the hollow tapered rod can include a small diameter that permits the antenna to fit in the small tank nozzle. In still another embodiment, the antenna can provide or include a high gain, a very low return loss, and a low side lobe over a radar bandwidth.

In another embodiment, a method of configuring a dielectric hollow antenna can be implemented, which includes the steps or logical operations of providing a waveguide configured from a hollow inside tapered rod with a flat section and a cap; locating a low loss dielectric material within the hollow inside tapered rod, which protrudes beyond the waveguide to form a radiating element; and forming a feed through section, a feed pin, and a metal flange, wherein the feed through section reduces an internal reflection, and the antenna is installed via a tank nozzle for radar level gauging and to withstand high temperatures.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A dielectric hollow antenna apparatus, comprising:
a waveguide configured from a hollow inside tapered rod with a flat section and a cap;
a low loss dielectric material located within said hollow inside tapered rod, which protrudes beyond said waveguide to form a radiating element; and
a feed through section, a feed pin, and a metal flange, wherein said feed through section reduces an internal reflection, and said antenna is installed via a tank nozzle for radar level gauging and to withstand high temperatures.

2. The apparatus of claim 1 wherein said waveguide comprise a waveguide that supports a TE01 propagation mode and then transitions to a circular waveguide that supports a TE11 propagation mode.

3. The apparatus of claim 1 wherein said radiating element is configured to maximize radiation and minimize reflection over an antenna bandwidth.

4. The apparatus of claim 1 wherein said dielectric material comprises a material capable of withstanding high-temperatures.

5. The apparatus of claim 1 wherein said hollow tapered rod comprises a small diameter that permits said antenna to fit in said small tank nozzle.

6. The apparatus of claim 1 wherein said antenna comprises a high gain, a very low return loss, and a low side lobe over a radar bandwidth.

7. The apparatus of claim 2 wherein said dielectric material comprises a material capable of withstanding high-temperatures.

8. The apparatus of claim 2 wherein said hollow tapered rod comprises a small diameter that permits said antenna to fit in said small tank nozzle.

9. A dielectric hollow antenna apparatus, comprising:
a waveguide configured from a hollow inside tapered rod with a flat section and a cap;
a low loss dielectric material located within said hollow inside tapered rod, which protrudes beyond said waveguide to form a radiating element; and
a feed through section, a feed pin, and a metal flange, wherein said feed through section reduces an internal reflection, and said antenna is installed via a tank nozzle for radar level gauging and to withstand high temperatures, wherein said radiating element is configured to maximize radiation and minimize reflection over an antenna bandwidth.

10. The apparatus of claim 9 wherein said waveguide comprise a waveguide that supports a TE01 propagation mode and then transitions to a circular waveguide that supports a TE11 propagation mode.

11. The apparatus of claim 9 wherein said dielectric material comprises a material capable of withstanding high-temperatures.

12. The apparatus of claim 9 wherein said hollow tapered rod comprises a small diameter that permits said antenna to fit in said small tank nozzle.

13. The apparatus of claim 9 wherein said antenna comprises a high gain, a very low return loss, and a low side lobe over a radar bandwidth.

14. The apparatus of claim 10 wherein said dielectric material comprises a material capable of withstanding high-temperatures.

15. The apparatus of claim 10 wherein said hollow tapered rod comprises a compact diameter that permits said antenna to fit in said small tank nozzle.

16. A method of configuring a dielectric hollow antenna, said method comprising:
providing a waveguide configured from a hollow inside tapered rod with a flat section and a cap;
locating a low loss dielectric material within said hollow inside tapered rod, which protrudes beyond said waveguide to form a radiating element; and
forming a feed through section, a feed pin, and a metal flange, wherein said feed through section reduces an internal reflection, and said antenna is installed via a tank nozzle for radar level gauging and to withstand high temperatures.

17. The method of claim 16 further comprising configuring said waveguide as a waveguide that supports a TE01 propagation mode and then transitions to a circular waveguide that supports a TE11 propagation mode.

18. The method of claim 16 further comprising configuring said radiating element to maximize radiation and minimize reflection over an antenna bandwidth.

19. The method of claim 16 wherein said dielectric material comprises a material capable of withstanding high-temperatures and wherein said hollow tapered rod comprises a small diameter that permits said antenna to fit in said small tank nozzle.

20. The method of claim 16 wherein said antenna comprises a high gain, a very low return loss, and a low side lobe over a radar bandwidth.
